(19) United States
(12) Patent Application Publication
(10) Pub. No.: US 2011/0069380 A1
(43) Pub. Date: Mar. 24, 2011

(54) VARIABLE MICROSCOPE SYSTEM

(75) Inventor: Jörg Sprenger, Jena (DE)

(73) Assignee: CARL ZEISS MICROIMAGING GMBH, Jena (DE)

(21) Appl. No.: 12/886,252

(22) Filed: Sep. 20, 2010

(30) Foreign Application Priority Data
Sep. 18, 2009 (DE) 10 2009 041 994.2

(51) Int. Cl. G02B 21/02; G02B 21/20

(52) U.S. Cl. 359/375; 359/380

(57) ABSTRACT

A variable microscope system, which, beginning at the object plane, includes a main lens system, a zoom lens system consisting of several lens groups, and a relay system connected in series to the zoom lens system. In the microscope system, according to the invention, at least one main lens system for infinite mapping of an object is provided and the zoom lens system is designed in such a way that the infinite beam path from the lens system is mapped in an intermediate image, wherein an aperture collimation is provided in a subsequently positioned relay system. An advantage of the microscope system, according to the invention, versus prior art lies in an improved eye pupil adjustment to the illumination as well as to the observation of samples with the contrast method.

This application claims priority to German Patent Application No. 10 2009 041 994.2 filed on Sep. 18, 2009, said application is incorporated herein by reference in it's entirety.

### FIELD OF THE INVENTION

The invention relates to a variable microscope system, which, beginning at the object plane, comprises a main lens system, a zoom lens system consisting of several lens groups, and a relay system connected in series to the zoom lens system.

### BACKGROUND OF THE INVENTION

In principle, microscope systems of this general type are known. Thereby, the adjustment of the zoom to the lens system and tube interface is of vital importance and must be inventively solved every time a new system of this type is to be developed (see SPIE Vol. 3482 XP009013507).

If an illumination is to be coupled in via the zoom system—with the advantage of an automatically adjusted field and aperture illumination—the entrance and exit pupils of the individual components must be synchronized as precisely as possible. This applies to the position of the pupils as well as their diameters.

The pupil adjustment defines the aperture for the imaging beam path across the zoom area as well the high vignetting, which is frequently connected thereto and varies with the zoom position. In this respect problems occur, particularly with the coaxial illumination since the object functions as an additional reflective element requiring a separate pupil adjustment for the illumination light and the reflected light.

While in higher magnification compound microscopes a magnification change is inevitably connected to a lens change, zoom systems are traditionally used in stereo microscopes due to lower magnifications and smaller apertures seen in stereo microscopes. Beginning with switchable Galilean systems, the transition was made to continuously operating afocal zoom systems with positive angular magnification during the course of further developments, as described, e.g., in DE 202 07 780 U1, DE 198 37 135 A1, and DE 103 59 733 A1.

Such systems are installed in the parallel beam path between the lens system and the tube lens. They are characterized by a relatively short transfer size and an aperture, usually positioned inside the system.

Said aperture is mapped on reciprocating pupil images through the respective motion sequence of the zoom components. This also applies to the system described in US 2006/0092504, whereby, however, the mapping of the aperture in the direction of the tube lens, i.e., the exit pupil, is compensated through the additional utilization of a third adjustable lens group.

Even though this comes closer to a solution for the problem of coupling an illumination via the zoom system, a trouble-free coaxial illumination is still not possible due to the greatly migrating entrance pupil position.

In US 2006/0114554A1, a stable entrance pupil is created by means of a physical aperture positioned before the afocal zoom. However, hereby it is disadvantageous that the exit pupil position of the afocal zoom system varies greatly.

### SUMMARY OF THE INVENTION

Based on the aforementioned, the invention creates a variable microscope system which, compared to prior art, allows for an improved pupil adjustment with regard to illumination as well as with regard to the application of contrast methods. An advantage of the microscope system, according to the invention, versus prior art lies in an improved eye pupil adjustment to the illumination as well as to the observation of samples with the contrast method, such as phase contrast and differential interference contrast (DIC).

According to the invention, improvements over the prior art are made with a microscope system of the above described type, wherein
at least one main lens system for infinite mapping of an object is provided, and
the zoom lens system is designed such that the infinite beam path from the lens system is mapped in an intermediate image, wherein
an aperture collimation is provided in a subsequently positioned relay system.

The terms variable magnification system, zoom lens system, and zoom system shall be used as synonyms in the following description. If several main lens systems are assigned to the microscope system, according to the invention, they are interchangeable. Regardless of the deployed main lens system and the adjusted magnification, the intermediate image, according to embodiments of the invention, exhibits not only a fixed position but also a fixed image size.

The relay system for the mapping of the intermediate image is positioned in an eyepiece image plane or on a camera.

In connection with the mapping in an eyepiece image plane, the optical relay system can also be designed as an imaging system with a binocular tube.

Furthermore, the scope of the invention includes the provision of the microscope system, according to the invention, with a device for the reflection of an illumination beam path. In this case, it is advantageous to provide for a field stop in the intermediate image plane.

With the mapping of the object via the stationary intermediate image it is possible to adjust the entrance pupil as well as the exit pupil of the microscope system to the desired conditions, particularly to an illumination to be coupled in.

This option for pupil adjustment results primarily in an improved image quality during the application of microscopic contrast methods for reflected light and transmitted light imaging. The field stop adds to further improved contrast. Furthermore, high cleanness tolerances with regard to the optical assemblies near the intermediate image are avoided because, due to the relatively large aperture on the image side, the influence of small contaminants regarding wavefront deformation decreases.

### BRIEF DESCRIPTION OF THE DRAWINGS

In the following, the invention shall be further explained by embodiment examples.

FIG. 1 is a first embodiment example with a variable magnification system, which consists of three lens groups, a relay system, consisting of two lens groups with an aperture diaphragm positioned between said two lens groups, and a first variation of the coupling of the illumination light via a fiber;

FIG. 2 is a second embodiment example with a variable magnification system, which consists of four lens groups, a relay system, consisting, as in FIG. 1, of two lens groups with an aperture diaphragm positioned between said two lens groups, and a second variation of the coupling of the illumination light via a fiber.

### DETAILED DESCRIPTION

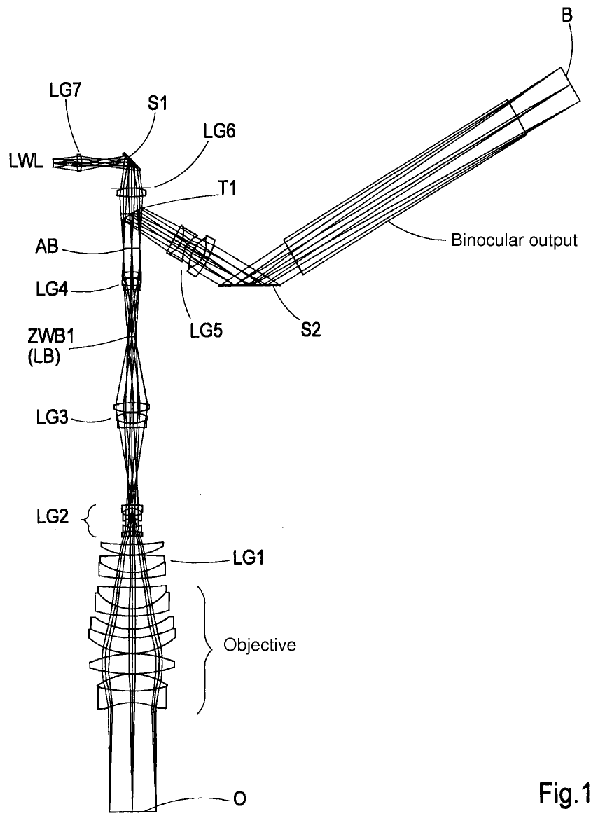

The design data of the first embodiment example in FIG. 1 are shown in the following table. For the main lens system applies:

| Area | Radius of | Thickness | Refractive index | Abbe number |
|---|---|---|---|---|
| FL | curvature r | d | nₑ | vₑ |
| 0 | | 63.860 | | |
| 1 | −44.931 | 6.765 | 1.72341 | 50.4 |
| 2 | 70.783 | 10.087 | 1.43985 | 94.6 |
| 3 | −40.742 | 0.100 | | |
| 4 | 103.148 | 12.000 | 1.43985 | 94.6 |
| 5 | −50.977 | 0.150 | | |
| 6 | 38.280 | 9.000 | 1.74791 | 44.6 |
| 7 | 64.674 | 5.000 | 1.51045 | 61.0 |
| 8 | 37.660 | 7.500 | | |
| 9 | 166.541 | 4.500 | 1.73739 | 51.2 |
| 10 | 26.500 | 12.500 | 1.48794 | 84.1 |
| 11 | −370.371 | 2.000 | | |

The zoom lens system in this example embodiment is designed with three lens groups LG1 to LG3 and the following data, wherein Z1 to Z3 designate the variable distances between the lens groups:

| | | | | |
|---|---|---|---|---|
| 12 | 84.234 | 4.000 | 1.61664 | 44.3 |
| 13 | 33.122 | 10.000 | 1.53019 | 76.6 |
| 14 | 6565.176 | 0.150 | | |
| 15 | 37.819 | 6.000 | 1.53019 | 76.6 |
| 16 | 84.405 | 28.099 | | |
| 17 | −37.135 | 3.000 | 1.88815 | 40.5 |
| 18 | −13.938 | 2.000 | 1.53430 | 48.5 |
| 19 | 11.327 | 4.842 | | |
| 20 | −10.799 | 2.000 | 1.57098 | 70.9 |
| 21 | 26.066 | 4.300 | 1.74791 | 44.6 |
| 22 | −12.366 | 2.000 | 1.75737 | 52.0 |
| 23 | −30.461 | 17.976 | | |
| 24 | −189.820 | 2.500 | 1.80650 | 34.7 |
| 25 | 18.443 | 6.000 | 1.43985 | 94.6 |
| 26 | −23.746 | 0.100 | | |
| 27 | 28.103 | 6.000 | 1.52679 | 70.1 |
| 28 | −26.743 | 44.507 | | |
| ZWB1 | | | | |

Through a variation of the distances Z1 to Z3 between the lens groups of the zoom lens system, focal lengths can be adjusted for example as follows:

| | f in mm | | | | | |
|---|---|---|---|---|---|---|
| | 11.4 mm | 13.8 mm | 22.2 mm | 34.8 mm | 70 mm | 140 mm |
| Z1 | 4.940 | 9.905 | 20.255 | 28.015 | 39.195 | 53.420 |
| Z2 | 47.196 | 41.250 | 28.280 | 17.900 | 5.013 | 11.995 |
| Z3 | 38.279 | 39.260 | 41.880 | 44.500 | 46.207 | 25.000 |
| S_{EP} | 44.9 | 55.4 | 81.3 | 100.8 | 85.1 | 313.1 |

In the table above, S_{EP} denotes the entrance pupil position with regard to the zoom lens system and for which a telecentric beam path is ensured in case of large object fields.

The zoom lens system is connected to a relay system with binocular output, which exhibits the following data:

| | | | | |
|---|---|---|---|---|
| 30 | −26.440 | 2.000 | 1.61664 | 44.3 |
| 31 | 24.321 | 4.000 | 1.43985 | 94.6 |
| 32 | −13.294 | 0.100 | | |
| 33 | 515.475 | 4.000 | 1.62286 | 60.1 |
| 34 | −32.383 | 20.864 | | |
| AB 36 | 0.000 | 60.000 | | |
| 37 | 102.461 | 5.000 | 1.76859 | 26.3 |
| 38 | −16.156 | 4.000 | 1.58212 | 53.6 |
| 39 | 17.509 | 11.642 | | |
| 40 | 24.792 | 7.000 | 1.53019 | 76.6 |
| 41 | −18.547 | 3.000 | 1.76859 | 26.3 |
| 42 | −107.112 | 61.500 | | |
| 43 | 0.000 | 162.000 | 1.51872 | 64.0 |
| 44 | 0.000 | 38.130 | | |
| ZWB2 | | | | |

The zoom factor ZF herein is 12.5×. AB in the above table denotes the aperture diaphragm, while ZWB2 denotes the second intermediate image plane.

FIG. 1 shows the optical assemblies of this embodiment example, structured as main lens system, zoom lens system, and relay system with binocular exit.

The object plane is designated with O. The lens system consists of seven lenses with the optically active areas 1 to 11 as listed in the table above. For example, the lens system has a focal length of f=80 mm.

The zoom lens system comprises the lens group LG1 with positive refractive power, lens group LG2 with negative refractive power, and lens group LG3 with positive refractive power.

The lens group LG1 consists of 3 lenses with the optically active areas 12 to 16 and is permanently positioned in the beam path. The lens group LG2 consists of five lenses with optically active areas 17 to 23 and is adjustable relative to the lens group LG1.

The lens group LG3 consists of three lenses with the optically active areas 24 to 28 and is adjustable relative to the lens groups LG1 and LG2.

Through the shift of the lens groups LG2 to LG4, the distances Z1 to Z3 are altered and, therefore, the magnification of the object image varied.

The intermediate image ZWB1 has a fixed position, which is independent from the respective positions of the lens groups LG2 to LG3 and therefore from the adjusted magnification.

The imaging system consists of the lens groups LG4 and LG5, between which the aperture diaphragm AB is positioned. The image plane has the designation B.

This example embodiment deviates from a fixed design of the pupil mapping in favor of a simpler zoom movement. Therefore, the entrance pupil position is no longer constant for all zoom positions but changes its position in accordance with the zoom position. However, since the adjustment of exit and entrance pupil position, as described above, is crucial for the illumination of large object fields, the entrance pupil position of the zoom lens system is adjusted in these zoom positions to the exit pupil position of the main lens system and deviates from this ideal position for greater magnification and therefore smaller object fields.

The relay system, connected in series to the zoom lens system, realizes the image reversal, so that a side-correct, upright image appears at the eyepiece exit. The aperture diaphragm AB positioned in the relay system presents advantages for the illumination as well as for the execution of simple tubes. The aperture diaphragm AB, fixed with regard to position and diameter, allows for a simple adjustment to a given light source, particularly with regard to the coupling of the illumination light via a fiber.

For example, as shown in FIG. 1, the mapping of the fiber end with additional optics LG6 and LG7 via a mirror S1, a beam splitter T1, and a mirror S2 is effected to the aperture diaphragm AB near the first lens group LG4 of the relay system. The introduction of the illumination light is effected with a light guide cable or liquid light guide LWL known from prior art.

The advantages of an aperture positioned in the relay system lie in the accessibility of the aperture as well as in the aperture-effected beam trajectory. Therefore, due to the tightest constriction of the beam bundles, the diameters of the beam splitter T1 and the subsequent illumination and/or the subsequent tube are minimal.

In one embodiment, the microscope system, according to the invention, is equipped with a relay system, which exhibits an infinite beam path. Via said infinite beam path, a universal microscope illumination, such as a halogen or HBO lamp, can be coupled in. A particularly simple variation results from the accessibility of the aperture diaphragm plane since a fiber exit positioned at this location, with a field stop at the first intermediate image ZWB1, represents a complete Koehler illumination.

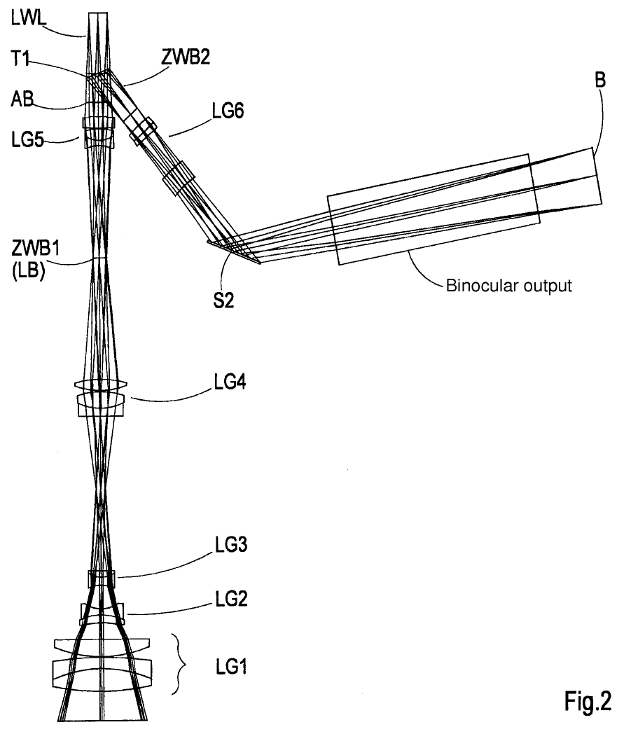

FIG. 2 shows a second example embodiment. Herein, the zoom lens system consists of four lens groups LG1 to LG4, and the relay system consists once again of two lens groups LG5 and LG6 with the aperture diaphragm AB between them.

If we look at the illustration of this fixed aperture diaphragm from the rear, i.e., from the relay system toward the object, we obtain in this embodiment example a fixed entrance pupil position for the zoom lens system across the entire zoom area. In this case, the zoom lens system is designed in such a way that the infinite beam path from the lens system produces a fixed intermediate image, and a fixed entrance pupil of the zoom lens system is mapped in a fixed exit pupil outside the zoom lens system. Due to this fixed entrance pupil position of the overall system, it is possible to realize a telecentric zoom on the object side with appropriate selection of the exit pupil position of the main lens system.

Notwithstanding the first embodiment example as shown in FIG. 1, FIG. 2 shows how it is possible to directly couple a fiber via the infinite beam path in the relay system at the point of the aperture diaphragm AB as well as to establish a sliding area for the subsequent binocular exit.

The zoom lens system hereto is, e.g., designed as follows:

| Area | Radius of | Thickness | Refractive index | Abbe number |
|---|---|---|---|---|
| FL | curvature r | D | nₑ | vₑ |
| 1 | 99.3139 | 8.000 | 1.48794 | 84.1 |
| 2 | −49.6449 | 4.000 | 1.70055 | 36.1 |
| 3 | −144.3994 | 0.150 | | |
| 4 | 50.0155 | 6.000 | 1.49845 | 81.0 |
| 5 | 1615.6495 | 40.580 | | |
| 6 | −47.8934 | 3.000 | 1.74791 | 44.6 |
| 7 | −17.8663 | 2.000 | 1.48915 | 70.1 |
| 8 | 13.3100 | 38.186 | | |
| 9 | −14.0449 | 3.000 | 1.49845 | 81.0 |
| 10 | 12.3340 | 2.000 | 1.67719 | 37.9 |
| 11 | 45.7264 | 6.393 | | |
| 12 | −127.7170 | 2.500 | 1.72539 | 34.5 |
| 13 | 18.6138 | 6.000 | 1.49845 | 81.0 |
| 14 | −26.4559 | 25.000 | | |
| 15 | 28.7094 | 4.000 | 1.52880 | 65.92 |
| 16 | −39.6605 | 25.000 | | |
| ZWB 1 | | | | |

Here the zoom factor ZF is 25×.

Through variation of the distances Z1 to Z4 between the lens groups of this zoom lens system, focal lengths f can be adjusted as follows.

| | f□ in mm | | | | | |
|---|---|---|---|---|---|---|
| | 10 mm | 16 mm | 25 mm | 50 mm | 100 mm | 250 mm |
| Z1 (D5) | 42.320 | 56.507 | 64.379 | 68.253 | 56.360 | 25.000 |
| Z2 (D8) | 54.010 | 24.513 | 18.600 | 15.407 | 12.082 | 6.390 |
| Z3 (D11) | 8.000 | 24.130 | 18.552 | 5.000 | 5.392 | 38.180 |
| Z4 (D16) | 5.820 | 5.000 | 8.619 | 21.490 | 36.316 | 40.580 |
| S_{EP} | 50 | 50 | 50 | 50 | 50 | 50 |

S_{EP} in the above table denotes the entrance pupil, onto which main lens systems are to be displayed, which are not further described herein.

The zoom lens system is connected to a relay system which, starting at the intermediate image ZWB1, exhibits the following data:

| Area | Radius of | Thickness | Refractive index | Abbe number |
|---|---|---|---|---|
| FL | curvature r | D | nₑ | vₑ |
| ZWB1 | | 38.996 | | |
| 18 | −14.9315 | 2.000 | 1.51045 | 61.0 |
| 19 | 10.7947 | 6.393 | 1.49845 | 81.0 |
| 20 | −17.4114 | 0.100 | | |
| 21 | 94.6144 | 4.000 | 1.49845 | 81.0 |
| 22 | −34.1390 | 40.000 | | |
| AB | Infinite | 5.000 | | |
| | 51.2072 | 3.000 | 1.53019 | 76.6 |
| | −153.8027 | 2.000 | 1.66883 | 35.7 |
| | Infinite | 15.020 | | |
| | 55.3108 | 7.500 | 1.62286 | 60.1 |
| | 33.4284 | 70.000 | | |
| | Infinite | 80.000 | 1.51872 | 64.0 |
| | Infinite | 25.000 | | |
| ZWB 2 | | | | |

If the aperture diaphragm plane were not directly reachable, it is possible to map the fiber exit by means of adjustment optics also at this location, as shown as an example in the embodiment, according to FIG. 1.

A further advantage of the infinity space in the relay system is the adjustability of the second group in the relay system and the resulting simple realization of ergonomic tubes. In addition, the second reflection—containing the image orientation—can be designed with an adjustable angle. Therefore, additional adjustments regarding ergonomics are possible.

If a camera exit is desired, the beam splitter T1 can, for example, be exchanged by a shift with another beam splitter T1 with deviating deflection angle.

With the imaging of the object via an intermediate image, the aperture, usually positioned in the zoom system, according to prior art, is bypassed, creating a real image for the pupil mapping. Since the aperture diaphragm in the relay system constitutes a conjugated plane with regard to the exit pupil of the main lens system, the option is hereby created to effect pupil procedures for contrast methods at this location. The fact that the diameter of the aperture as well as the angle of field at the aperture diaphragm behind the zoom lens system is constant throughout the entire zoom provides significant advantages for the design of the contrast devices.

For example, a reflected-light phase contrast method can be realized as shown in the embodiment example in accordance with FIG. 2. With a ring of fixed size on the illumination side, it is possible to illuminate through an aperture plane, which is split by the beam splitter T1. The phase ring conjugated thereto is to be positioned after the mirror in the imaging beam path.

The DIC method, more frequently used with reflected light, whereby a birefringent prism in the illumination and imaging beam path is equally effective, can also be realized due to the constant angle of field. The constant angle of field on the image side corresponds on the object side to image splitting of varying size, depending on the zoom. Since the numerical aperture on the object side also changes with the zoom, an automatic adjustment of image splitting and numerical aperture is ensured.

With contrast methods, such as phase contrast and differential interference contrast (DIC), the visualization of certain object details is achieved through pupil procedures. Due to the aperture, which is fixed in position and size over the entire zoom area, a Wollaston prism for differential angle splitting can be introduced as well as a reflected-light phase contrast be realized.

### LEGEND

LG1 to LG8 Lens groups
O Object plane
B Image plane
ZWB1 First intermediate image
ZWB2 Second intermediate image
AB Aperture diaphragm
S1, S2 Mirror
T1 Beam splitter
Z1 to Z4 Distances
LB Field stop

1. A variable microscope system, which, beginning at an object plane, comprises:
at least one main lens system; and
a zoom lens system consisting of one or several lens groups;
wherein
the main lens system for mapping of an object has an infinite beam path, and
the zoom lens system is structured such that the infinite beam path from the main lens system is mapped in a fixed intermediate image plane, wherein
aperture collimation is provided in a in series connected relay system.

2. The variable microscope system, according to claim 1, wherein the relay system is structured to map a first intermediate image in an eyepiece image plane or onto a camera.

3. The variable microscope system, according to claim 1, wherein the relay system comprises an imaging system with a binocular tube.

4. The variable microscope system, according to claim 1, further comprising an illumination beam path reflector and a field stop, positioned in the intermediate image plane.

5. The variable microscope system, according to claim 1, comprising the following design data:
Main lens system:

| Area | Radius of | Thickness | Refractive index | Abbe number |
|---|---|---|---|---|
| FL | curvature r | d | nₑ | vₑ |
| 0 | | 63.860 | | |
| 1 | −44.931 | 6.765 | 1.72341 | 50.4 |
| 2 | 70.783 | 10.087 | 1.43985 | 94.6 |
| 3 | −40.742 | 0.100 | | |
| 4 | 103.148 | 12.000 | 1.43985 | 94.6 |
| 5 | −50.977 | 0.150 | | |
| 6 | 38.280 | 9.000 | 1.74791 | 44.6 |
| 7 | 64.674 | 5.000 | 1.51045 | 61.0 |
| 8 | 37.660 | 7.500 | | |
| 9 | 166.541 | 4.500 | 1.73739 | 51.2 |
| 10 | 26.500 | 12.500 | 1.48794 | 84.1 |
| 11 | −370.371 | 2.000 | | |

Zoom lens system:

| | | | | |
|---|---|---|---|---|
| 12 | 84.234 | 4.000 | 1.61664 | 44.3 |
| 13 | 33.122 | 10.000 | 1.53019 | 76.6 |
| 14 | 6565.176 | 0.150 | | |
| 15 | 37.819 | 6.000 | 1.53019 | 76.6 |
| 16 | 84.405 | 28.099 | | |
| 17 | −37.135 | 3.000 | 1.88815 | 40.5 |
| 18 | −13.938 | 2.000 | 1.53430 | 48.5 |
| 19 | 11.327 | 4.842 | | |
| 20 | −10.799 | 2.000 | 1.57098 | 70.9 |
| 21 | 26.066 | 4.300 | 1.74791 | 44.6 |
| 22 | −12.366 | 2.000 | 1.75737 | 52.0 |
| 23 | −30.461 | 17.976 | | |
| 24 | −189.820 | 2.500 | 1.80650 | 34.7 |
| 25 | 18.443 | 6.000 | 1.43985 | 94.6 |
| 26 | −23.746 | 0.100 | | |
| 27 | 28.103 | 6.000 | 1.52679 | 70.1 |
| 28 | −26.743 | 44.507 | | |
| ZWB1 | | | | |

Focal lengths at variations of the distances Z1 to Z3:

| | f in mm | | | | | |
|---|---|---|---|---|---|---|
| | 11.4 mm | 13.8 mm | 22.2 mm | 34.8 mm | 70 mm | 140 mm |
| Z1 | 4.940 | 9.905 | 20.255 | 28.015 | 39.195 | 53.420 |
| Z2 | 47.196 | 41.250 | 28.280 | 17.900 | 5.013 | 11.995 |
| Z3 | 38.279 | 39.260 | 41.880 | 44.500 | 46.207 | 25.000 |
| S_{EP} | 44.9 | 55.4 | 81.3 | 100.8 | 85.1 | 313.1 |

Relay system with binocular exit:

| | | | | |
|---|---|---|---|---|
| 30 | −26.440 | 2.000 | 1.61664 | 44.3 |
| 31 | 24.321 | 4.000 | 1.43985 | 94.6 |
| 32 | −13.294 | 0.100 | | |
| 33 | 515.475 | 4.000 | 1.62286 | 60.1 |
| 34 | −32.383 | 20.864 | | |
| AB 36 | 0.000 | 60.000 | | |
| 37 | 102.461 | 5.000 | 1.76859 | 26.3 |
| 38 | −16.156 | 4.000 | 1.58212 | 53.6 |
| 39 | 17.509 | 11.642 | | |
| 40 | 24.792 | 7.000 | 1.53019 | 76.6 |
| 41 | −18.547 | 3.000 | 1.76859 | 26.3 |
| 42 | −107.112 | 61.500 | | |
| 43 | 0.000 | 162.000 | 1.51872 | 64.0 |
| 44 | 0.000 | 38.130 | | |
| ZWB2 | | | | |
